(19) United States
(12) Patent Application Publication
(10) Pub. No.: US 2021/0129320 A1
(43) Pub. Date: May 6, 2021

(54) METHOD FOR AUTOMATICALLY HANDLING OBJECTS

(71) Applicant: SICK AG, Waldkirch (DE)

(72) Inventors: Michael OVERDICK, Emmendingen (DE); Trevor STEWART, Gaienhofen (DE); Thomas BLÜMCKE, Emmendingen (DE); Markus KLEMM, Dresden (DE)

(21) Appl. No.: 17/083,567

(22) Filed: Oct. 29, 2020

(30) Foreign Application Priority Data
Oct. 31, 2019 (DE) 102019129417.7

(51) Int. Cl. B25J 9/16

(52) U.S. Cl. CPC B25J 9/1612; B25J 9/1694

(57) ABSTRACT

In a method for automatically handling objects, the objects are held by means of an object gripper or the like and are subjected to a handling process, a transport process, or an assembly process in the held state. The position of at least one surface section of the held object relative to a contact surface of the object gripper or the like is monitored by means of at least one position sensor arranged at the object gripper or the like; and a warning signal or control signal is generated in the event of a change of the position during the handling process, the transport process, or the assembly process.

The invention relates to a method for automatically handling objects in which the objects are held by means of an object gripper or the like and are subjected to a handling process, a transport process, or an assembly process in the held state.

The automatic handling of objects is significant in many areas of technology, for example, in the processing of products or in the conveying of materials. Accordingly, in the present disclosure, the term “objects” is to be understood as any desired components, assemblies, products, semi-finished products and packaging, but also as raw materials and other materials.

Robots that have an object gripper as an end effector are frequently used in the automatic object handling. An automatic object handling in the sense of the present disclosure can also be carried out by means of holding apparatus, lifting apparatus, and transport apparatus. The objects can in this respect be held by an object gripper or by an object holder.

In the field of object handling, it is generally important to maintain a predefined object position so that the handling process, the transport process, or the assembly process is carried out correctly. Even if a deviation from the desired position only occurs relatively rarely, this can lead to an unacceptable impairment of the system availability and/or of the product quality due to the high throughput of common production lines.

It is therefore endeavored to increase the reliability of automatic object handling processes.

The object is satisfied by a method having the features of claim 1.

In a method in accordance with the invention, provision is made that the position of at least one surface section of the held object relative to a contact surface of the object gripper or the like is monitored by means of at least one position sensor arranged at the object gripper or the like; and a warning signal or control signal is generated in the event of a change of the position during the handling process, the transport process, or the assembly process.

A simple recognition of error situations such as a slipping of the held object is possible by monitoring the object position for changes during the handling process, the transport process, or the assembly process. It is not absolutely necessary in a method in accordance with the invention to determine the actual object position or to classify the object so that the effort is relatively low. Time-consuming teaching processes can in particular be avoided. An advantage of the invention comprises that damage to the objects, that is, for example, a breaking during a handling process, a transport process, or an assembly process, can also be recognized since the positions of surface sections of the object relative to the contact surface likewise change in this respect.

It can be ensured by means of the warning signal or control signal that a slipping of or damage to a held object does not impair the subsequent processes, for example, by carrying out a position correction by means of a placement and a new gripping or by supplying the damaged object to a reject container. Accordingly, it is preferred that the warning signal or control signal is supplied to a control device that is able to introduce compensation measures. However, an optical and/or acoustic warning signal may also be sufficient in certain applications.

The objects are preferably moved during the handling process, the transport process, or the assembly process. In principle, however, it could also be the case, for example, that the held object is stationary during the handling process, the transport process, or the assembly process and a processing tool is moved relative to the stationary object.

In the present text, an automatic object handling is to be understood such that it can generally also take place by means of manually controlled object grippers or object holders. Objects that are disposed on an object support should likewise be considered as “held”, namely in the sense that their position relative to the support surface is defined. The method in accordance with the invention can be particularly advantageous if the objects are held by means of an automatically controlled and/or automatically moved object gripper or the like. Provision can in particular advantageously be made that the objects are automatically handled in the sense that the handling process, the transport process, or the assembly process is subject to an independent process control or has a programmed sequence.

The position of the at least one surface section is preferably repeatedly or continuously detected.

It is not absolutely necessary for the monitoring to actually associate the signal of the position sensor with one or more specific surface sections of the object. Rather, it may also be sufficient to analyze the total signal in a general manner since it is influenced by the entirety of the surface sections of the object.

Provision can be made that the position of the surface section is monitored by a transit time measurement, by an amplitude evaluation, and/or by a signal shape evaluation. A transit time measurement is advantageous to the extent that the position sensor only requires a relative time system and can therefore have a comparatively simple design. In contrast to this, tactile sensors usually require a relatively complex design of the associated object gripper such as the provision of movable plates. A position sensor can be used for the transit time measurement that has a transmitter, a receiver, and a control circuit configured for time difference measurements. Error situations such as a slipping of the held object can be recognized based on changes of the signal amplitude of a signal received from the position sensor. Depending on the application situation, an amplitude reduction or an amplitude increase can indicate an error in this respect. Furthermore, an evaluation of the signal signature of a part of the signal or of the total signal can take place. This means that the signal course can be analyzed very generally, wherein the signal course is considered similarly to a fingerprint.

The position of the surface section could be monitored by means of at least one radar sensor. However, in accordance with a preferred embodiment of the invention, the position of the surface section is monitored by means of at least one ultrasonic transducer. Ultrasonic transducers are relatively compact and inexpensive. In addition, they only have a low proneness to disturbance, in particular in the near zone, and are not impaired or are hardly impaired by typical environmental conditions. A further advantage is that ultrasonic transducers are robust with respect to contamination of the boundary surfaces.

Provision can be made that the positions of a plurality of or all of the observed surface sections of the held object are simultaneously monitored, in particular by means of respective position sensors. This enables a particularly exact position monitoring. Object rotations or object damage can in particular be recognized at different positions in this manner.

A specific embodiment of the invention provides that the position of the surface section is detected and stored before the handling process, the transport process, or the assembly process and the position of the surface section is then repeatedly or continuously detected again during the handling process, the transport process, or the assembly process over a predefined monitoring period and is compared with the stored position. This means that it can be assumed that the object is present in the desired position at a predefined point in time that preferably lies after the gripping or holding, but still before the start of the handling process, the transport process or the assembly process. Any change of the position then means an unwanted deviation from the desired position. A comparison between the stored position and the current position is possible in a particularly simple manner, for example, by means of a subtraction step. The monitoring period can extend over the total handling process, transport process, or assembly process or can be identical to it.

The position of the surface section is preferably newly detected and stored before each handling process, transport process, or assembly process. The definition of an absolute desired position is then not necessary. In addition, different objects can be handled without a teaching being necessary.

Provision can be made that a deviation between a currently detected position and the stored position is determined and the warning signal or control signal is generated when the deviation exceeds a predefined threshold value. This can be performed in a simple and inexpensive manner by means of a comparator or the like. The threshold value can be defined in an application-specific manner.

The invention also relates to an apparatus for automatically handling objects, comprising an object gripper or the like that has at least one contact surface for a holding contact with an object; and at least one position sensor that is arranged at the object gripper or the like.

In an apparatus in accordance with the invention, the position sensor is configured to monitor the position of at least one surface section of the held object relative to a contact surface of the object gripper or the like. Furthermore, an apparatus in accordance with the invention has an electronic control device that is in signal connection with the at least one position sensor and that is configured to generate a warning signal or control signal in the event of a change of the position during a handling process, a transport process, or an assembly process.

Despite its inexpensive design, such an apparatus is able to recognize error situations such as a slipping of a held object.

The electronic control device can be configured to perform a method as described above during the operation of the apparatus.

The at least one position sensor is preferably an ultrasonic transducer. Alternatively, the at least one position sensor could also be a radar sensor.

A specific embodiment of the invention provides that the ultrasonic transducer has a sound output surface and is arranged at the object gripper or the like such that the sound output surface can be brought into contact with a held object without an air gap, that is, it is, for example, at least substantially flush with the contact surface. The ultrasonic transducer can then be operated in direct contact with the object. This enables a measurement that is based solely on a transmission of structure-borne sound. A propagation of the ultrasonic waves through the air is then not necessary, which simplifies the design of the apparatus since fewer reflections occur.

In accordance with a further embodiment of the invention, a plurality of ultrasonic transducers are provided at different positions of the object gripper or the like and/or in different orientations. This enables a particularly exact monitoring of the object position and in particular also of the object location, that is, for example, of the rotational position of the object.

Further developments of the invention can also be seen from the dependent claims, from the description, and from the enclosed drawing.

The invention will be described in the following by way of example with reference to the drawing.

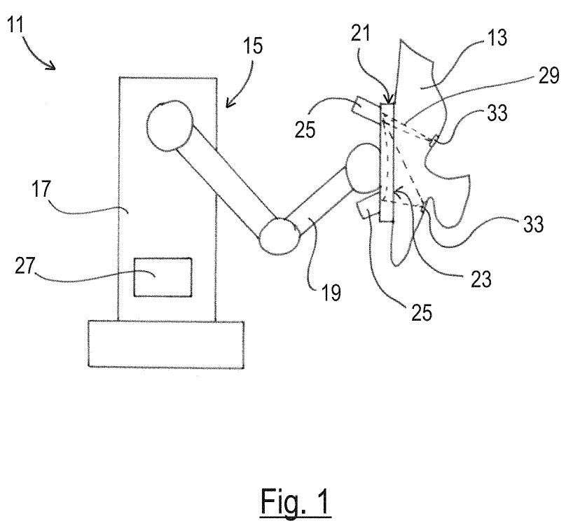

FIG. 1 is a simplified side view of an apparatus in accordance with the invention for automatically handling objects;

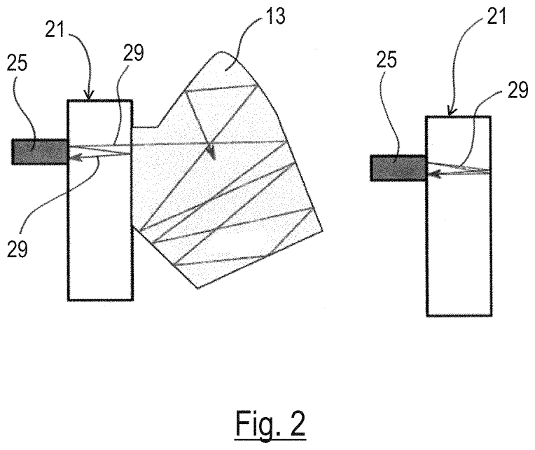

FIG. 2 shows an object gripper of an alternatively designed apparatus in accordance with the invention for automatically handling objects once with an object and once without an object; and

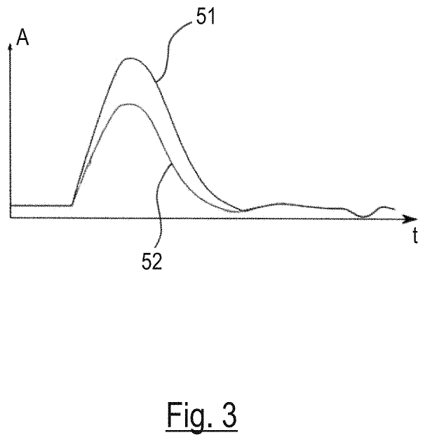

FIG. 3 shows an exemplary time curve of a sensor signal of the apparatus shown in FIG. 2 for a situation with an object and without an object respectively.

The apparatus 11 shown in FIG. 1 serves for the automatic handling of an object 13 and comprises a robot 15 that in a known manner has a fixed-position base 17, movable kinematics 19, and an end effector in the form of an object gripper 21. The object gripper 21 is only shown schematically and can, depending on the application, be designed as a pincer gripper, a magnetic gripper, or a suction gripper. As can be seen from FIG. 1, the object gripper 21 has a contact surface 23 that is configured for a contact with the object 13 to be gripped. The contact surface 23 can be planar as shown so that it is suitable for an areal contact of a planar surface of the object 13. The object 13 can be any desired product that is to be supplied to a processing.

Two ultrasonic transducers 25 are arranged at the object gripper 21 such that their sound output surfaces are to be brought into contact with the held object 13 without an air gap. The ultrasonic transducers 25 are preferably designed as transducers and can thus work as sound wave transmitters and sound wave receivers (both not shown in FIG. 1). In the embodiment shown, the two ultrasonic transducers 25 are each arranged at a marginal region of the object gripper 21. The ultrasonic transducers 25 are in signal connection with an electronic control device 27 that is shown in an exemplary manner in the region of the base 17, but could also be integrated into the object gripper 21.

The sound wave transmitters of the ultrasonic transducers 25 transmit ultrasonic signals 29 during the operation of the apparatus 11. The transmitted ultrasonic signals 29 propagate as structure-borne sound in the held object 13 and are reflected by surface sections 33 of the object 13. The reflected ultrasonic signals 29 are received and evaluated by the associated sound wave receivers of the ultrasonic transducers 25. Thus, the position of different surface sections 33 relative to the contact surface 23 of the object gripper 21 can be detected by means of the ultrasonic transducers 25. For reasons of clarity, only two exemplary surface sections 33 are shown in FIG. 1.

The electronic control device 27 is configured to monitor the positions of a plurality of surface sections 33 of the held object 13 relative to the contact surface 23 by means of the ultrasonic transducers 25 and to generate a warning signal or control signal in the event of a change of the position during the handling process, the transport process, or the assembly process. The electronic control device 27 is specially configured to detect generally received ultrasonic signals 29 and to generate the warning signal or control signal in the event of any changes of the received ultrasonic signals 29.

For the monitoring, the received ultrasonic signals, that is the echo values, are detected and stored before each handling process, transport process, or assembly process. The echo values are then repeatedly or continuously detected again during the handling process, the transport process, or the assembly process and are compared with the stored echo values. The warning signal or control signal is generated each time a deviation occurs and the deviation exceeds a predefined threshold. It then namely has to be assumed that the object 13 has slipped or has been damaged. The electronic control device 27 can be configured to cause a placement and a new gripping of the object 13 when a warning signal or control signal is present.

It is also possible to recognize damage to the object gripper 21 by storing an object-free signal and comparing it with a later object-free signal.

The invention is particularly advantageous for robots 15 having object grippers 21, but it could also be used for lifting apparatus or transport apparatus. For example, the object support of a belt conveyor, not shown, or of a driverless transport system could form a contact surface 23 on which a slipping of the object 13 is determined.

It can be recognized in FIG. 2 that an increase in the amplitude of the received ultrasonic signals 29 can result due to an object loss. If the object 13 is located at the object gripper 21 as in the left part of FIG. 2, the received signal only has a low amplitude since the object 13 acts as a sound absorber and reflects the ultrasonic signals 29 away from the ultrasonic transducer 25. If no object is present as in the right part of FIG. 2, the received ultrasonic signal 29 in contrast has a relatively high amplitude. The corresponding course of the signal amplitudes A in dependence on the time t is shown in FIG. 3, wherein the upper curve 51 corresponds to the situation without an object and the lower curve 52 to the situation with an object. The curves 51, 52 can be monitored with respect to certain characteristics in order to distinguish between individual situations in this manner.

### REFERENCE NUMERAL LIST

11 apparatus for automatically handling objects
13 object
15 robot
17 base
19 kinematics
21 object gripper
23 contact surface
25 ultrasonic transducer
27 electronic control device
29 ultrasonic signal
33 surface section

1. A method for automatically handling objects in which method the objects are held in a held state by means of an object gripper or the like and are subjected to one of a handling process, a transport process, and an assembly process in the held state,
wherein the position of at least one surface section of the held object relative to a contact surface of the object gripper or the like is monitored by means of at least one position sensor arranged at the object gripper or the like; and
one of a warning signal and a control signal is generated in the event of a change of the position during one of the handling process, the transport process, and the assembly process.

2. The method in accordance with claim 1,
wherein the position of the at least one surface section is repeatedly or continuously detected.

3. The method in accordance with claim 1,
wherein the position of the surface section is monitored by at least one of a transit time measurement, an amplitude evaluation, and a signal shape evaluation.

4. The method in accordance with claim 1,
wherein the position of the surface section is monitored by mean of a east one ultrasonic transducer.

5. The method in accordance with claim 1,
wherein positions of a plurality of surface sections of the held object are simultaneously monitored.

6. The method in accordance with claim 5,
wherein the positions of a plurality of surface sections of the held object are simultaneously monitored by means of respective position sensors.

7. The method in accordance with claim 1,
wherein the position of the surface section is detected and stored before the one of the handling process, the transport process, and the assembly process and the position of the surface section is then repeatedly or continuously detected again during said one of the handling process, the transport process, and the assembly process over a predefined monitoring period and is compared with the stored position.

8. The method in accordance with claim 7,
wherein the position of the surface section is newly detected and stored before each one of the handling process, the transport process, and the assembly process.

9. The method in accordance with claim 7,
wherein a deviation between a currently detected position and the stored position is determined and the warning signal or control signal is generated if the deviation exceeds a predefined threshold value.

10. An apparatus for automatically handling objects, the apparatus comprising an object gripper or the like that has at least one contact surface for a holding contact with an object; at least one position sensor that is arranged at the object gripper or the like and that is configured to monitor the position of at least one surface section of the held object relative to a contact surface of the object gripper or the like; and an electronic control device that is in signal connection with the at least one position sensor and that is configured to generate a warning signal or control signal in the event of a change of the position during one of a handling process, a transport process, and an assembly process.

11. The apparatus in accordance with claim 10,
wherein the electronic control device is configured to perform a method for automatically handling objects during the operation of the apparatus, in which method the objects are held in a held state by means of the object gripper or the like and are subjected to said one of the handling process,
the transport process, and the assembly process in the held state, wherein the position of at least one surface section of the held object relative to a contact surface of the object gripper or the like is monitored by means of said at least one position sensor arranged at the object gripper or the like; and
one of a warning signal and a control signal is generated in the event of a change of the position during one of the handling process, the transport process, and the assembly process.

12. The apparatus in accordance with claim 10,
wherein the at least one position sensor is an ultrasonic transducer.

13. The apparatus in accordance with claim 12,
wherein the ultrasonic transducer has a sound output surface and is arranged at the object gripper or the like such that the sound output surface can be brought into contact with a held object without an air gap.

14. The apparatus in accordance with claim 12,
wherein a plurality of ultrasonic transducers are provided at different positions of the object gripper or the like and/or in different orientations.
